(19) United States
(12) Patent Application Publication
(10) Pub. No.: US 2019/0072239 A1
(43) Pub. Date: Mar. 7, 2019

(54) FULL-COVER LED BULB WITH LARGE-ANGLE ILLUMINATION

(71) Applicants: Li Xin Thomas Li, Wan Chai (HK); Yi Yang, Changsha (CN); Zhongping Liu, Guangzhou (CN)

(72) Inventors: Li Xin Thomas Li, Wan Chai (HK); Yi Yang, Changsha (CN); Zhongping Liu, Guangzhou (CN)

(21) Appl. No.: 16/123,987

(22) Filed: Sep. 6, 2018

(30) Foreign Application Priority Data
Sep. 7, 2017 (CN) 2017211430341

(51) Int. Cl. F21K 9/232; F21K 9/235; F21K 9/238; F21V 29/503; F21V 19/00; F21V 31/00; F21V 17/12; F21V 17/10; F21K 9/237; F21V 29/70

(52) U.S. Cl. CPC F21K 9/232; F21K 9/235; F21K 9/238; F21V 29/503; F21V 19/0015; F21Y 2115/10; F21V 17/12; F21V 17/101; F21K 9/237; F21V 29/70; F21V 31/005

(57) ABSTRACT

A full-cover LED bulb with large-angle illumination includes a lamp cap, a lamp cover, a substrate, an LED driver power supply, at least one LED and at least one heat conducting metal strip, wherein the LED driver power supply is fixedly connected to the substrate and electrically connected thereto; the substrate is fixed to and electrically connected to the lamp cap; the lamp cover is fixedly connected to lamp cap and the lamp cover defines an internal space; the at least one heat conducting metal strip is welded at two ends to substrate, and each heat conducting metal strip is bent and arches toward the internal space; and the at least one LED is welded to the heat conducting metal strip. In the case of the LED bulb with the structure, the irradiation capability of all LEDs is maximized, the irradiation angle is large, and the brightness is uniform.

### CROSS-REFERENCE TO RELATED APPLICATIONS

This application claims priority to Chinese Application No. CN2017211430341 having a filing date of Sep. 7, 2017, the entire contents of which are hereby incorporated by reference.

### FIELD OF TECHNOLOGY

The present invention relates to the field of LED lighting technology, and in particular relates to a full-cover LED bulb with large-angle illumination.

### BACKGROUND

A light emitting diode, abbreviated as LED, is made of a compound containing gallium (Ga), arsenic (As), phosphorus (P), nitrogen (N), or the like. It is a type of semiconductor diode, and can convert electrical energy into light energy. Like an ordinary diode, the light emitting diode is composed of a PN junction and also has unilateral conductivity. After a forward voltage is applied to the light emitting diode, holes injected from a P region into an N region and electrons injected into the P region from the N region are respectively recombined with the electrons in the N region and the holes in the P region within a few micrometers near the PN junction to generate fluorescence with spontaneous radiation. The energy states of electrons and holes in different semiconductor materials are different. The amount of energy released during the recombination of electrons and holes is different. The more energy is released, the shorter the wavelength of the emitted light is.

With the progress of LED lighting technology, LED lamps have gradually replaced incandescent lamps and energy-saving lamps in the traditional lighting field due to their advantages of energy conservation, long service life, environmental protection and the like, and have been accepted and recognized by people. However, most of the LED bulbs on the market are half-cover bulbs, as shown in FIG. 1, which is a structural diagram of an LED bulb in the prior art. Chinese patent No. 201620558943.0 discloses an LED bulb, including a lamp cap nut 100, a lamp holder 200 connected to the upper end of the lamp cap nut, an LED light source structure mounted in the lamp holder 200, and a light transmissive cover 300 fixedly disposed on the lamp holder 200, and further including a driving device disposed within the lamp holder 200 and electrically connected to the LED light source structure. In the LED bulb with the structure, the light transmissive cover 300 is hemispherical, and the LED light source structure is disposed in the lamp holder 200. During illumination, light can only be radiated through the hemispherical light transmissive cover 300, with a small angle and strong directivity of illumination, and is locally too bright, so that the eyes feel uncomfortable and are prone to visual fatigue. Nowadays, in the society where the quality of life is getting higher and higher, LED bulbs for lighting are required to be omnidirectional and also uniform in light intensity distribution. In 2009, the United States released a new standard for LED lighting. In the standard, the light intensity distribution of omnidirectional LED bulbs is required to be uniform and bright within the range of 270 degrees in the lateral and lower area of the bulb; and the luminous flux within the range of 90 degrees at the top shall not be too small. Therefore, there is still much room for improvement in the existing LED bulbs.

### SUMMARY

On this basis, the present invention aims at providing a full-cover LED bulb with large-angle illumination which is large in irradiation angle and uniform in brightness.

The full-cover LED bulb with large-angle illumination includes a lamp cap, a lamp cover, a substrate, an LED driver power supply, at least one LED (Light Emitting Diode) and at least one heat conducting metal strip, wherein the substrate is provided with a connecting circuit, and the LED driver power supply is fixedly connected to the substrate and electrically connected thereto; the lamp cap has a surface for mounting the substrate, and the substrate is fixed to the surface and electrically connected to the lamp cap; the lamp cover is fixedly connected to lamp cap and the lamp cover defines an internal space; the at least one heat conducting metal strip is welded at two ends to substrate, and each heat conducting metal strip is bent and arches toward the internal space; and the at least one LED is welded to the heat conducting metal strip and electrically connected to the LED driver power supply through the heat conducting metal strip. In the case of the LED bulb with the structure, as the heat conducting metal strip having the LED welded thereon projects, in a bent manner, into the internal space defined by the lamp cover, the LED is completely unshielded, so that the irradiation capability of all LEDs is maximized, the irradiation angle is large, and the brightness is uniform.

Further, the heat conducting metal strip is bent into a circular, arc, triangular, square or inwardly concave shape. The heat conducting metal strip can be bent into different shapes according to different conditions, and its use is flexible.

Further, there are a plurality of heat conducting metal strips welded to the substrate and arranged in a staggered manner, and each heat conducting metal strip has LEDs welded thereon. This configuration ensures more uniform brightness of the LED bulb.

Further, each heat conducting metal strip has a plurality of LEDs welded thereon at intervals. This configuration ensures more uniform brightness of the LED bulb.

Further, one or more parts of the heat conducting metal strip are bent into spiral springs. This configuration further improves the heat dissipation effect of the heat conducting metal strip.

Further, the LEDs are connected in parallel.

Further, the LEDs are connected in series.

Further, the gap between the substrate and the lamp cap is filled with thermal adhesive. The thermal adhesive has excellent resistance to cold and hot alteration, aging resistance and electrical insulation, and has outstanding resistance to moisture, shock, corona, electrical leakage and chemical mediator. When it is applied to the bonding of the substrate and the lamp cap, the bulb can be more durable.

Further, a closed end of the lamp cover is spherical, and an open end thereof extends away from the spherical center to form an opening connected to the lamp cap. The lamp cover with the structure allows the light irradiation angle of the LED to be larger.

Further, the lamp cover is in threaded connection with the lamp cap or connected thereto by nailing. This configuration makes the LED bulb easy to disassemble and assemble and simple to maintain.

Compared with the prior art, the full-cover LED bulb with large-angle illumination of the present invention includes a full lamp cover, and the heat conducting metal strip with a plurality of LEDs welded thereon is bent into various shapes and projects into the lamp cover; the LEDs so configured are not shielded, so that the radiation angle of the light is wide, the brightness is uniform, the visual effect is comfortable and fatigue is not liable to occur; and the heat conducting metal strip has both functions of electric conduction and heat dissipation, so the LED bulb has a simple structure, low cost and long service life.

The present invention is described in detail below in conjunction with the drawings for better understanding and implementation.

### BRIEF DESCRIPTION OF THE DRAWINGS

FIG. 1 is a structural diagram of an LED bulb in the prior art;

FIG. 2 is a structural diagram of embodiment 1 of a full-cover LED bulb with large-angle illumination of the present invention;

FIG. 3 is a top view of embodiment 1 of a full-cover LED bulb with large-angle illumination of the present invention;

FIG. 4 is a connection diagram of a heat conducting metal strip and an LED in embodiment 1;

FIG. 5 is a structural diagram of embodiment 2 of a full-cover LED bulb with large-angle illumination of the present invention;

FIG. 6 is a top view of embodiment 2 of a full-cover LED bulb with large-angle illumination of the present invention;

FIG. 7 is a connection diagram of a heat conducting metal strip and an LED in embodiment 2;

FIG. 8 is a structural diagram of embodiment 3 of a full-cover LED bulb with large-angle illumination of the present invention; and

FIG. 9 is a connection diagram of a heat conducting metal strip and an LED in embodiment 3.

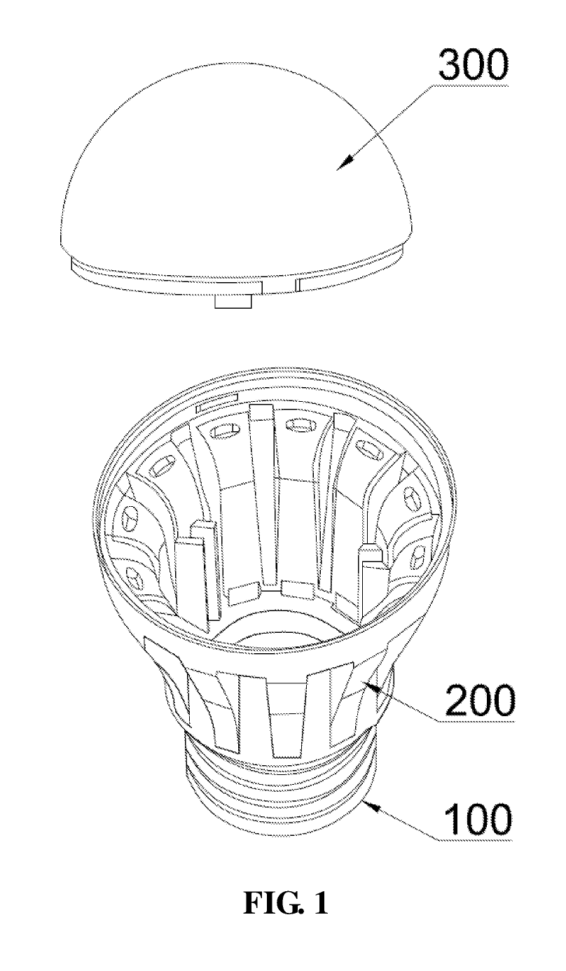

### DETAILED DESCRIPTION

Now referring to the following drawings, the present invention is described more fully. Embodiments of the present invention are shown in the drawings. However, the present invention can be embodied in various different forms, and should not be understood as limited to the particular embodiments set forth herein. Specifically, these embodiments are used for conveying the scope of the present invention to those skilled in the art.

Unless otherwise defined, the terms (including technical and scientific terms) used herein should be understood as having the same meanings as commonly understood by one of ordinary skill in the art to which the present invention pertains. Moreover, it is to be understood that the terms used herein should be understood as having meanings consistent with those in the present specification and the related art, and should not be interpreted in an ideal or overly formal sense unless so specified explicitly herein.

### Embodiment 1

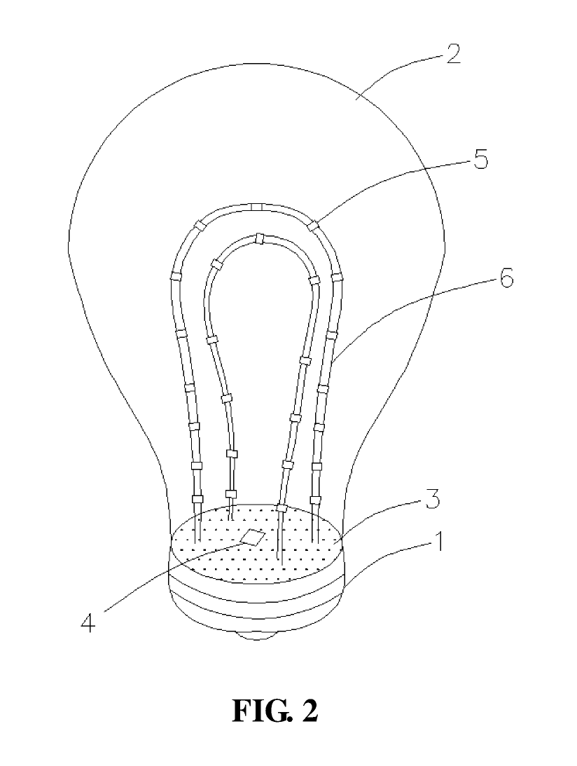

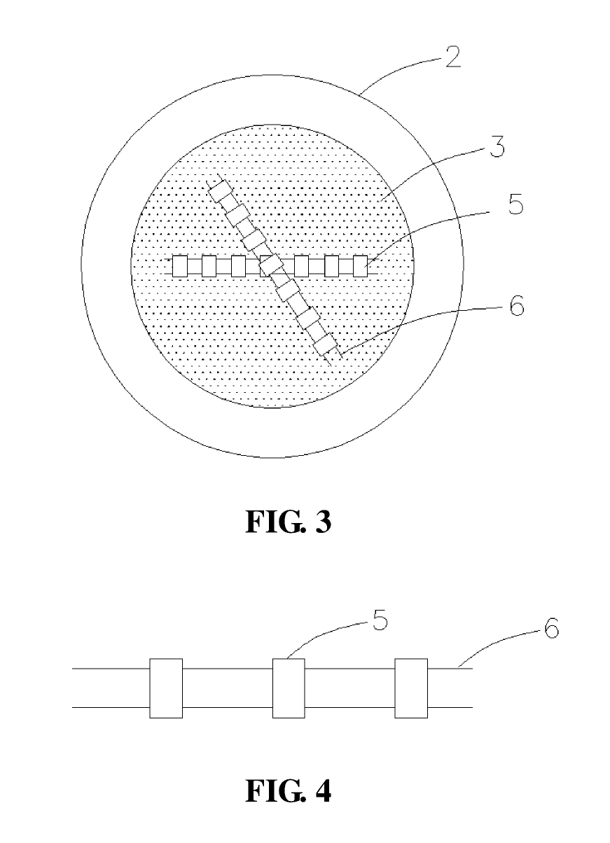

As shown in FIGS. 2 and 3, FIG. 2 is a structural diagram of embodiment 1 of a full-cover LED bulb with large-angle illumination of the present invention, and FIG. 3 is a top view of embodiment 1 of the full-cover LED bulb with large-angle illumination of the present invention. The full-cover LED bulb with large-angle illumination includes a lamp cap 1, a lamp cover 2, a substrate 3, an LED driver power supply 4, at least one LED (Light Emitting Diode) 5 and at least one heat conducting metal strip 6, wherein the substrate 3 is provided with a connecting circuit, and the LED driver power supply 4 is fixedly connected to the substrate 3 and electrically connected thereto; the lamp cap 1 has a surface for mounting the substrate 3, and the substrate 3 is fixed to the surface and electrically connected to the lamp cap 1; the lamp cover 2 is fixedly connected to lamp cap 1, and the lamp cover 2 covers the substrate 3 to define an internal space; the at least one heat conducting metal strip 6 is welded at two ends to substrate 3, and each heat conducting metal strip 6 is bent and arches toward the internal space; and the at least one LED 5 is welded to the heat conducting metal strip 6 and electrically connected to the LED driver power supply 4 through the heat conducting metal strip 6. In the case of the full-cover LED bulb with large-angle illumination of the present invention, the heat conducting metal strip 6 welded to the substrate 3 supports the LED 5, and has both electric conduction and heat dissipation effects. As the LED 5 is suspended at a hollow position, its brightness can be maximized, the irradiation angle is large, and the brightness is uniform.

Specifically, the heat conducting metal strip 6 can be bent into a circular, arc, triangular, square or inwardly concave shape. In the embodiment, the heat conducting metal strip 6 is bent into a circular arc shape. There are a plurality of heat conducting metal strips 6 welded to the substrate 3 and arranged in a staggered manner, and the heat conducting metal strips 6 have LEDs 5 welded thereon. Each heat conducting metal strip 6 has a plurality of LEDs 5 welded thereon at intervals. The plurality of LEDs 5 may be arranged at equal intervals, and may also be arranged at any other regular intervals.

As shown in FIG. 4, FIG. 4 is a connection diagram of the heat conducting metal strip and the LED in embodiment 1. In the embodiment, the LEDs 5 are connected in parallel, and therefore every two pieces of the heat conducting metal strip 6 jointly connect a plurality of LEDs 5.

Preferably, the gap between the substrate 3 and the lamp cap 1 is filled with thermal adhesive; a closed end of the lamp cover 2 is spherical, and an open end thereof extends away from the spherical center to form an opening connected to the lamp cap; and the lamp cover 2 is in threaded connection with the lamp cap 1, and may also be connected thereto by nailing.

### Embodiment 2

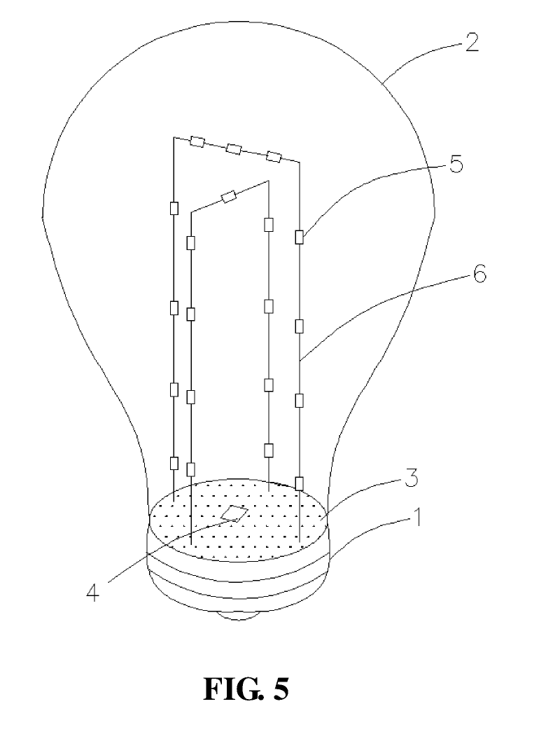

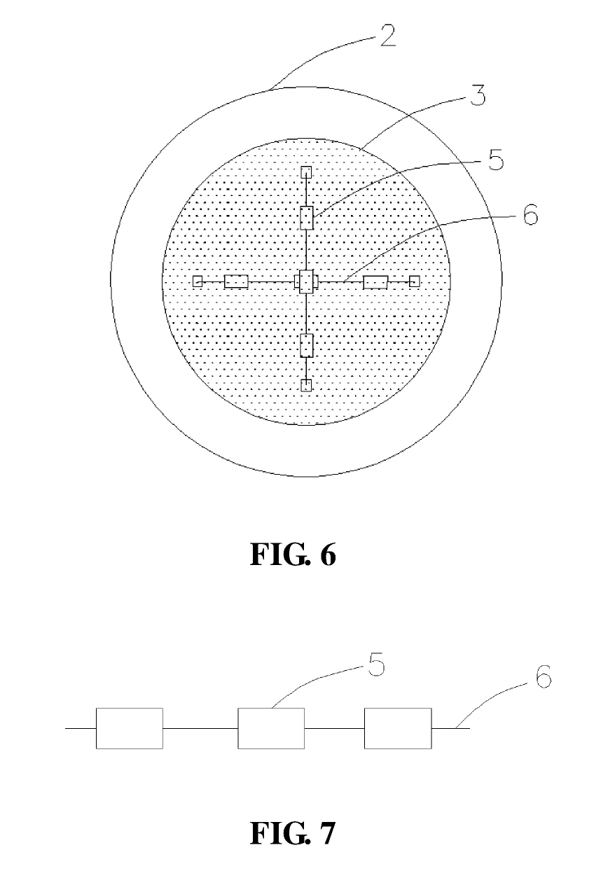

As shown in FIGS. 5 and 6, FIG. 5 is a structural diagram of embodiment 2 of a full-cover LED bulb with large-angle illumination of the present invention, and FIG. 6 is a top view of embodiment 2 of the full-cover LED bulb with large-angle illumination of the present invention. The full-cover LED bulb with large-angle illumination includes a lamp cap 1, a lamp cover 2, a substrate 3, an LED driver power supply 4, at least one LED (Light Emitting Diode) 5 and at least one heat conducting metal strip 6, wherein the substrate 3 is provided with a connecting circuit, and the LED driver power supply 4 is fixedly connected to the substrate 3 and electrically connected thereto; the lamp cap 1 has a surface for mounting the substrate 3, and the substrate 3 is fixed to the surface and electrically connected to the lamp cap 1; the lamp cover 2 is fixedly connected to lamp cap 1, and the lamp cover 2 covers the substrate 3 to define an internal space; the at least one heat conducting metal strip 6 is welded at two ends to substrate 3, and each heat conducting metal strip 6 is bent and arches toward the internal space; and the at least one LED 5 is welded to the heat conducting metal strip 6 and electrically connected to the LED driver power supply 4 through the heat conducting metal strip 6. In the case of the full-cover LED bulb with large-angle illumination of the present invention, the heat conducting metal strip 6 welded to the substrate 3 supports the LED 5, and has both electric conduction and heat dissipation effects. As the LED 5 is suspended at a hollow position, its brightness can be maximized, the irradiation angle is large, and the brightness is uniform.

Specifically, the heat conducting metal strip 6 can be bent into a circular, arc, triangular, square or inwardly concave shape. In the embodiment, the heat conducting metal strip 6 is bent into a square shape. There are a plurality of heat conducting metal strips 6 welded to the substrate 3 and arranged in a staggered manner, and the heat conducting metal strips 6 have LEDs 5 welded thereon. Each heat conducting metal strip 6 has a plurality of LEDs 5 welded thereon at intervals. The plurality of LEDs 5 may be arranged at equal intervals, and may also be arranged at any other regular intervals.

As shown in FIG. 7, FIG. 7 is a connection diagram of the heat conducting metal strip and the LED in embodiment 2. In the embodiment, the LEDs 5 are connected in series, and therefore each piece of heat conducting metal strip 6 connects a plurality of LEDs 5.

Preferably, the gap between the substrate 3 and the lamp cap 1 is filled with thermal adhesive; a closed end of the lamp cover 2 is spherical, and an open end thereof extends away from the spherical center to form an opening connected to the lamp cap; and the lamp cover 2 is in threaded connection with the lamp cap 1, and may also be connected thereto by nailing.

### Embodiment 3

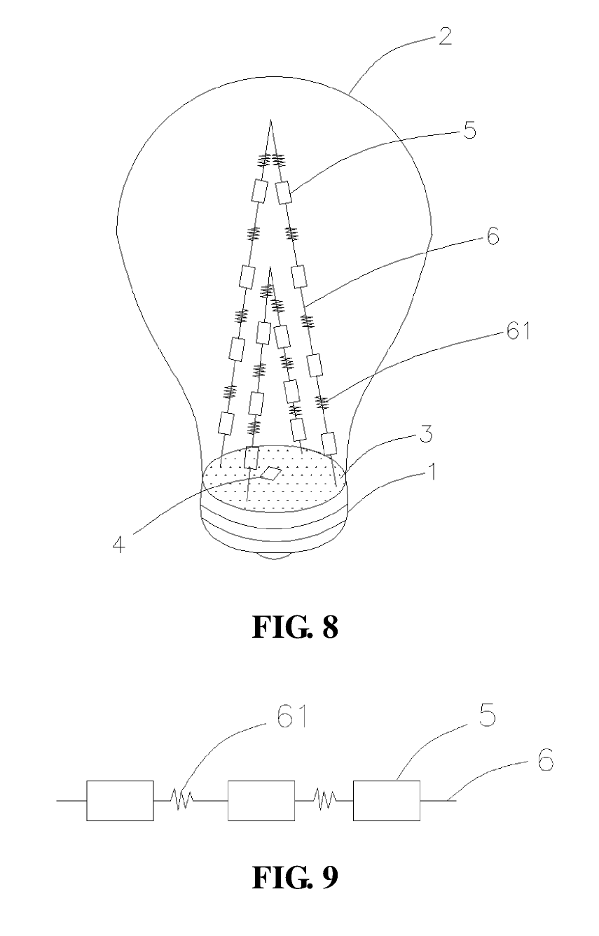

As shown in FIG. 8, FIG. 8 is a structural diagram of embodiment 3 of a full-cover LED bulb with large-angle illumination of the present invention. The full-cover LED bulb with large-angle illumination includes a lamp cap 1, a lamp cover 2, a substrate 3, an LED driver power supply 4, at least one LED (Light Emitting Diode) 5 and at least one heat conducting metal strip 6, wherein the substrate 3 is provided with a connecting circuit, and the LED driver power supply 4 is fixedly connected to the substrate 3 and electrically connected thereto; the lamp cap 1 has a surface for mounting the substrate 3, and the substrate 3 is fixed to the surface and electrically connected to the lamp cap 1; the lamp cover 2 covers the substrate 3 and is fixedly connected to lamp cap 1 to define an internal space; the at least one heat conducting metal strip 6 is welded at two ends to substrate 3, and each heat conducting metal strip 6 is bent and arches toward the internal space; and the at least one LED 5 is welded to the heat conducting metal strip 6 and electrically connected to the LED driver power supply 4 through the heat conducting metal strip 6. In the case of the full-cover LED bulb with large-angle illumination of the present invention, the heat conducting metal strip 6 welded to the substrate 3 supports the LED 5, and has both electric conduction and heat dissipation effects. As the LED 5 is suspended at a hollow position, its brightness can be maximized, the irradiation angle is large, and the brightness is uniform.

Specifically, the heat conducting metal strip 6 can be bent into a circular, arc, triangular, square or inwardly concave shape. In the embodiment, the heat conducting metal strip 6 is bent into a square shape. There are a plurality of heat conducting metal strips 6 welded to the substrate 3 and arranged in a staggered manner, and the heat conducting metal strips 6 have LEDs 5 welded thereon. Each heat conducting metal strip 6 has a plurality of LEDs 5 welded thereon at intervals. The plurality of LEDs 5 may be arranged at equal intervals, and may also be arranged at any other regular intervals.

As shown in FIG. 9, FIG. 9 is a connection diagram of the heat conducting metal strip and the LED in embodiment 3. In the embodiment, the LEDs 5 are connected in series, and therefore each piece of heat conducting metal strip 6 connects a plurality of LEDs 5. In addition, one or more parts of the heat conducting metal strip 6 in the embodiment are bent into toothed protrusions 61, and this structure ensures a better heat dissipation effect of the heat conducting metal strip 6.

Preferably, the gap between the substrate 3 and the lamp cap 1 is filled with thermal adhesive; a closed end of the lamp cover 2 is spherical, and an open end thereof extends away from the spherical center to form an opening connected to the lamp cap; and the lamp cover 2 is in threaded connection with the lamp cap 1, and may also be connected thereto by nailing.

In operation, the lamp cap 1 is connected to a power source, and the power is input to the LED driver power source 4 through the substrate 3 to drive the LED 5 welded on the heat conducting metal strip 6. The heat conducting metal strip 6 functions as a connecting circuit, and also has a heat dissipation function.

Compared with the prior art, the full-cover LED bulb with large-angle illumination of the present invention includes a full lamp cover, and the heat conducting metal strip with a plurality of LEDs welded thereon is bent into various shapes and projects into the lamp cover; the LEDs so configured are not shielded, so that the radiation angle of the light is wide, the brightness is uniform, the visual effect is comfortable and fatigue is not liable to occur; and the heat conducting metal strip has both functions of electric conduction and heat dissipation, so the LED bulb has a simple structure, low cost and long service life.

The embodiments described above only represent several implementations of the present invention, and the description thereof is relatively concrete and detailed, but it cannot be construed as limiting the patent scope of the invention. It should be noted that a number of modifications and improvements may be made by those of ordinary skill in the art without departing from the concept of the present invention, and these modifications and improvements are encompassed within the protection scope of the invention.

1. A full-cover LED bulb with large-angle illumination includes a lamp cap, a lamp cover, a substrate, an LED driver power supply, at least one LED and at least one heat conducting metal strip, wherein the substrate is provided with a connecting circuit, and the LED driver power supply is fixedly connected to the substrate and electrically connected thereto; the lamp cap has a surface for mounting the substrate, and the substrate is fixed to the surface and electrically connected to the lamp cap; the lamp cover is fixedly connected to lamp cap and the lamp cover defines an internal space; the at least one heat conducting metal strip is welded at two ends to substrate, and each heat conducting metal strip is bent and arches toward the internal space; and the at least one LED is welded to the heat conducting metal strip and electrically connected to the LED driver power supply through the heat conducting metal strip.

2. The full-cover LED bulb with large-angle illumination of claim 1, wherein the heat conducting metal strip is bent into a circular, arc, triangular, square or inwardly concave shape.

3. The full-cover LED bulb with large-angle illumination of claim 2, wherein there are a plurality of heat conducting metal strips welded to the substrate and arranged in a staggered manner, and each heat conducting metal strip has LEDs welded thereon.

4. The full-cover LED bulb with large-angle illumination of claim 3, wherein each heat conducting metal strip has a plurality of LEDs welded thereon at intervals.

5. The full-cover LED bulb with large-angle illumination of claim 4, wherein one or more parts of the heat conducting metal strip are bent into spiral springs.

6. The full-cover LED bulb with large-angle illumination of claim 5, wherein the LEDs are connected in parallel.

7. The full-cover LED bulb with large-angle illumination of claim 5, wherein the LEDs are connected in series.

8. The full-cover LED bulb with large-angle illumination of claim 6, wherein the gap between the substrate and the lamp cap is filled with thermal adhesive.

9. The full-cover LED bulb with large-angle illumination of claim 7, wherein the gap between the substrate and the lamp cap is filled with thermal adhesive.

10. The full-cover LED bulb with large-angle illumination of claim 8, wherein a closed end of the lamp cover is spherical, and an open end thereof extends away from the spherical center to form an opening connected to the lamp cap.

11. The full-cover LED bulb with large-angle illumination of claim 9, wherein a closed end of the lamp cover is spherical, and an open end thereof extends away from the spherical center to form an opening connected to the lamp cap.

12. The full-cover LED bulb with large-angle illumination of claim 10, wherein the lamp cover is in threaded connection with the lamp cap or connected thereto by nailing.

13. The full-cover LED bulb with large-angle illumination of claim 11, wherein the lamp cover is in threaded connection with the lamp cap or connected thereto by nailing.
